(19) United States
(12) Patent Application Publication
(10) Pub. No.: US 2026/0301497 A1
(43) Pub. Date: Oct. 1, 2026

(54) ULTRA-WIDEBAND INTENT DETECTION USING MOBILE DEVICE MOTION SENSORS

(71) Applicant: ASSA ABLOY AB, Stockholm (SE)

(72) Inventor: Robert Kjell Rowe, Poulsbo, WA (US)

(21) Appl. No.: 19/089,307

(22) Filed: Mar. 25, 2025

(51) Int. Cl. G07C 9/29; G01S 13/02

(52) U.S. Cl. CPC G07C 9/29; G01S 13/0209

(57) ABSTRACT

A reader device of a physical access control system includes an ultra-wide band (UWB) physical layer and processing circuitry. The processing circuitry is operatively coupled to the UWB physical layer and is configured to detect presence of a person using a UWB signal, establish a communication channel with a credential device associated with the person, receive Inertial Measurement Unit (IMU) information from the credential device using the communication channel, determine intent regarding whether the person intends to access a physical access portal associated with the reader device using the IMU information, and initiate authentication of the credential device when the determined intent indicates the person intends to access the physical access portal.

### TECHNICAL FIELD

Embodiments illustrated and described herein generally relate to system architectures for physical access control systems.

### BACKGROUND

Seamless access control refers to when physical access is granted to an authorized user through a controlled portal without requiring intrusive actions of the user such as entering or swiping an access card at a card reader or entering a personal identification number (PIN) or password. A Physical Access Control System (PACS) is a type of system that can provide seamless access. A PACS authenticates and authorizes a person to pass through a physical access point such as a secured door. It is desirable for the devices that control the access to the physical portal to be able to correctly determine whether a credential device holder intends seamless access to the controlled physical access portal or if the credential device holder is merely passing by the controlled physical access portal.

### BRIEF DESCRIPTION OF THE DRAWINGS

FIG. 1 is an illustration of an example of a basic Physical Access Control System (PACS) structure.

FIG. 2 is a flow diagram of an example of a method of operating a PACS.

FIG. 3 is a block diagram of an example of an ultra-wide band (UWB) capable device and a UWB capable credential device.

FIG. 4 is a flow diagram is a flow diagram of an example of a method of device-based detection of intent to access a physical access portal.

FIG. 5 is a block diagram of portions of another example of a PACS.

FIG. 6 is a block diagram schematic of portions of a device for supporting the device architectures described and illustrated herein.

### DETAILED DESCRIPTION

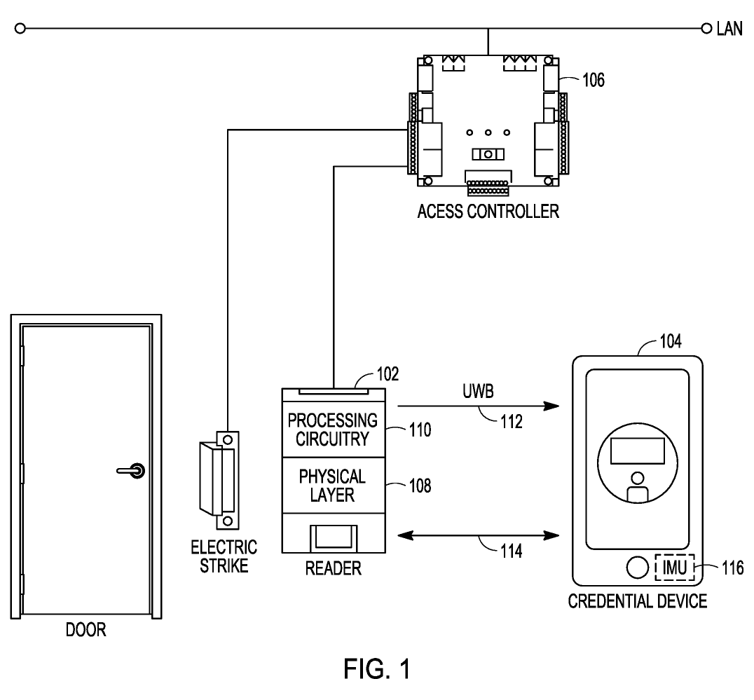

FIG. 1 is an illustration of an example of a basic PACS structure. The example PACS may be useful for an office application. The Access Credential is a data object, a piece of knowledge (e.g., PIN, password, etc.), or a facet of the person’s physical being (e.g., face, fingerprint, etc.) that provides proof of the person’s identity. The Credential Device 104 stores the Access Credential when the Access Credential is a data object. The Credential Device 104 may be a smart card, smartphone, or tablet computer. The Reader Device 102 retrieves and authenticates the Access Credential when a Credential Device 104 is used and sends the Access Credential to the Access Controller 106. The Access Controller 106 compares the Access Credential to an Access Control list and grants or denies access based on the comparison, such as by controlling an automatic lock on a door for example. The functionality of an Access Controller 106 may be included in the Reader Device 102. These Reader Devices can be referred to as offline readers or standalone readers. If the unlocking mechanism is included as well, a device is referred to as smart door lock which is more typically used in residential applications.

An alternative approach is “match on device” where the Credential Device 104 (whether a smartphone or smartcard) checks the user’s identity and stores a biometric, PIN, or password in a secure storage element of the Credential Device 104. The Credential Device 104 may also store an Access Control List in the secure storage element. The Credential Device 104 checks if the user has authorization to enter. If there is a match and the user is authorized, the Credential Device 104 sends an authorization signal to the Reader Device or the Access Controller to grant access. If there is not a match and the user is not authorized, the Credential Device 104 may do nothing, or may display a notice that the user is not authorized.

For physical access applications, an electronic device needs to authenticate a person, which can require different methodologies than those used for electronic devices authenticating each other. Authentication methods for persons are typically split into three broad categories: “Something you know,” “Something you have,” or “Something you are.” For a PACS, “Proof of Presence” is as important as the authentication when granting access through a particular physical portal at a given moment in time.

Impulse Radio Ultra-Wideband (IR-UWB, or simply UWB) can provide Proof of Presence information in a secure manner. UWB is a radio communication methodology that uses a wide signal bandwidth. The wide bandwidth is typically defined as either a -10 decibel (-10dB) bandwidth greater than 20% of the center frequency of the signal, or a bandwidth greater than 500 megahertz (500MHz) in absolute terms. UWB uses short, low power, pulses over a wide frequency spectrum. The pulses are on the order of millions of individual pulses per second. Commercial UWB systems are intended to be used in complex environments such as residential, office, or industrial indoor areas. In these environments, signal reflection and diffraction play a significant role. The signal received by an antenna is the sum of the attenuated, delayed and possibly overlapping versions of the transmitted signal and may vary over time (due to movement of receiver/transmitter or change in environment). These different versions of the transmitted signal are typically referred to as multipath components. The large bandwidth of UWB systems provides a high level of resilience to frequency selective fading, which is an effect that can limit the performance of narrow-band technologies.

The secure and accurate ranging capability of UWB makes it a suitable technology to enable seamless access because the ranging can be used to determine Presence without a need for actions by the user. For example, UWB sensing may be incorporated into a protected doorway (e.g., in the Reader Device 102) in order to determine the presence and location of a person carrying a Credential Device 104. Once such a person, or device of a person is sensed, the PACS may then perform follow-up actions such as determining which side of the entry the person is on, and whether the Credential Device 104 they are carrying contains a valid digital credential. Under the right conditions, such a door may unlock for a person with a valid credential with the proper privileges.

In order to conduct a seamless interaction at a protected physical access, it is also important to be able to understand a person’s intent. A person holding a valid credential with proper privileges to unlock a door may be walking by in close proximity to the door but not intending to pass through. In such cases, the door should not unlock, which would have a variety of negative consequences. These negative consequences include creating a security vulnerability, wasting energy, and creating anomalous entries in security logs. For this reason, a well-functioning intent detection is important.

The Credential Device 104 may include an Inertial Measurement Unit (IMU 116). IMUs include motion sensors such as 3-axis accelerometers and 3-axis gyroscopes for example. Smartphones and other mobile devices (e.g., tablet computers, smart watches, and other wearable devices) include IMUs and can be used as Credential Devices. IMUs can be used for motion tracking and gesture recognition, screen orientation detection, navigation and location services, image stabilization for cameras, and step counting and fitness tracking. Some IMUs include a magnetometer to measure magnetic fields to determine direction. The signals produced by an IMU present in the Credential Device 104 being carried by the person approaching a Reader Device 102 of an access to a controlled space may be extracted and processed for a seamless estimation of Intent of a person to pass through the access portal.

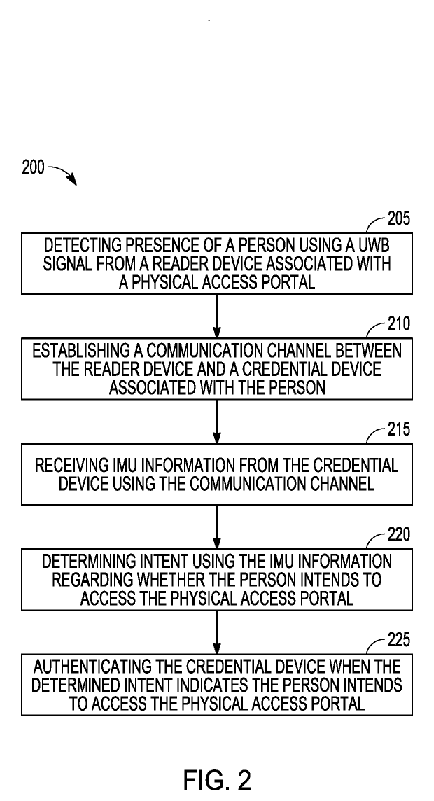

FIG. 2 is a flow diagram of an example of a method 200 of operating a PACS. The method 200 can be performed by the PACS of FIG. 1 and provides seamless access to the space controlled by the PACS. In the example PACS of FIG. 1, the Reader Device 102 (or Reader & Access Controller Device) controls access to the physical access portal (e.g., a door) used to enter the controlled space. The Reader Device 102 is UWB enabled and includes a UWB physical layer 108 and processing circuitry 110 operatively coupled to the UWB physical layer 108. The processing circuitry 110 may include one or more processors (e.g., microprocessors), application specific integrated circuit (ASIC), programmable gate array (PGA), or other processing logic. The processing circuitry may be configured to perform the functions described using executable instructions included in one or both of hardware and firmware.

At block 205 of FIG. 2, the processing circuitry 110 of the Reader Device 102 detects Presence of the Credential Device 104 or the person carrying the Credential Device 104 using UWB signals 112. In the example of FIG. 1, the Credential Device 104 is a UWB enabled smartphone that includes an IMU 116.

At block 210, the processing circuitry 110 establishes a communication channel 114 with the Credential Device 104 in response to detecting the presence of the Credential Device 104 or person. At block 215, the processing circuitry 110 receives IMU information from the Credential Device 104 using the communication channel 114.

At block 220, the processing circuitry 110 uses the IMU information to determine Intent regarding whether the person intends to access a physical access portal or is just passing by the physical access portal. The IMU information may include raw signals produced by the sensors of the IMU. The processing circuitry 110 of the Reader Device processes the signals to determine if there is movement of the person that indicates an intent to pass through the physical access portal. For example, the processing circuitry 110 may detect angular motion of the person carrying the Credential Device 104 such as when the person turns toward the physical access portal for access.

In some examples, the processing circuitry 110 of the Credential Device 104 processes the signals output from the IMU sensors to identify actions of the person carrying the Credential Device 104. For instance, the Credential Device 104 may send IMU information to the Reader Device 102 that the person is turning left or right. The processing circuitry 110 may detect that the person intends to enter the physical access portal if the turning is toward the physical access portal.

As explained previously herein, UWB signals can be used to determine Presence of the person carrying the Credential Device 104. In some examples, the processing circuitry 110 both the UWB signals 112 and the IMU information from the Credential Device 104 to determine Intent of the person.

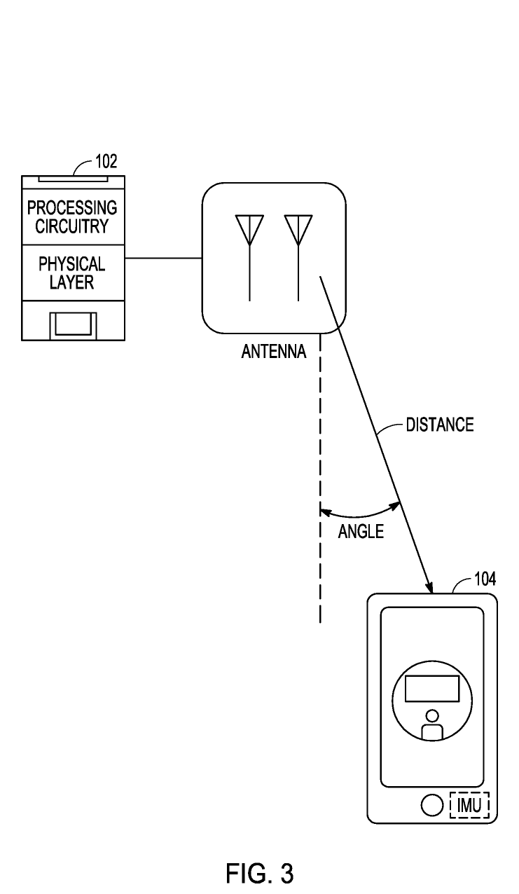

FIG. 3 is a block diagram of an example of a UWB capable Reader Device 102 (or Reader & Access Controller Device) and a UWB capable Credential Device 104. The UWB capable devices can determine Presence and Intent of the person carrying the Credential Device 104 using Time-of-Flight (ToF) and Angle-of-Arrival (AoA). The UWB capable devices may use Two Way Ranging (TWR) for ToF. In TWR, radio packets are exchanged between the Reader Device 102 and the Credential Device 104. The timing differences for the transmitting and receiving of the packets between the Reader Device 102 and the Credential Device 104 can be used by the processing circuitry 110 to calculate ranging information such as change in radial distance. The Reader Device 102 may use two antennas to receive a UWB signal form the Credential Device 104 and compare the phase difference between the signal received by the antennas to determine AoA of the user.

The processing circuitry 110 can use both the UWB ranging and the IMU information to determine intent. The UWB and IMU signals may use different coordinate systems. For instance, the raw UWB signals can include estimates of radial distance and angle of arrival and may use a two-dimensional coordinate system of angle and radius (e.g., θ, R polar coordinates). The raw signals from the IMU may include linear accelerations in a three-dimensional X, Y, and Z coordinate system and angular accelerations around the X, Y, and Z axes. The processing circuitry 110 may transform the raw signals of the IMU to the coordinate system of the UWB signals to determine intent (e.g., transform acceleration signals from the X, Y, and Z coordinate system to the polar coordinate system). In some examples, the raw signals from the IMU may be converted to world coordinates to make them relatively insensitive to the way that the mobile device is being carried by the user.

The combined signals from the IMU and the UWB may be processed to determine intent in a variety of ways. For instance, the processing circuitry 110 may use UWB signals to determine the change in distance with time of the person from the physical access portal using the UWB signal. The processing circuitry 110 may use the IMU information to determine angular motion of the person. Decreasing distance between the person and the access portal and angular motion of the person toward the access portal may indicate the person is approaching the access portal and turning toward the access portal and intends to pass through the portal. Angular motion away from the access portal may indicate that the person intends to pass by the access portal without entering. Using the combination of change in distance and angular motion may provide better accuracy in the processing circuitry 110 determinations of Intent to enter the portal.

In another example, the processing circuitry 110 may use the IMU information to determine change in speed of the person (e.g., through a change in stride length, stride frequency, or a combination of both stride length and frequency). The combination of deceasing distance of the person to the access portal and slowing of the person in the plane of the hallway of the access portal may indicate that the person intends to pass through the portal. Conversely, if the person isn’t slowing as they near the access portal, the processing circuitry 110 may determine that the person is not intending to enter the access portal. If the user is a person in a wheelchair, the processing circuitry may use change in speed and angle using the IMU information.

In some examples, “semi-raw” signals from one or both of the IMU and UWB are used to determine intent. IMU information collected may include position data and acceleration data in world coordinates (e.g., position data in X, Y, Z, and acceleration data in the X, Y, and Z directions or AccelX, AccelY, AccelZ). The collected IMU information in world coordinates may be concatenated with UWB data that is in either polar coordinates or X, Y, Z coordinates. Both forms of semi-raw signals (e.g., world coordinate IMU data and X, Y, Z coordinate UWB data) may be created by the respective motion sensor systems of the Credential Device 104 and the Reader Device 102. A time series of such data can be collected (e.g., 10-30 Hertz motion data collected over a second or more) and then fed into a machine learning model (e.g., a recurrent neural network (e.g., long short-term memory (LSTM) recurrent neural network, or decision tree ensemble). The output of the machine learning model may be trained to determine between “intent to enter” and “not intent to enter.” The output of the machine model may be trained away from a simple binary result so that IMU data and UWB data that does not clearly show “intent to enter” does not result in opening of the physical access portal.

Returning to FIG. 2 at block 225, the processing circuitry 110 initiates authentication of the Credential Device 104 when detecting an Intent of the person to access the physical access portal. The authentication may include the Reader Device 102 sending a request to the Credential Device 104 for an access credential. In response to the request, the Credential Device 104 sends the access credential to the Reader Device 102 via the communication channel 114. If the access credential is valid and is authenticated by the Reader Device 102, the person is granted access and the physical access portal is opened by the Access Controller 106. If the access credential is not authenticated, the physical access portal is not opened. If the processing circuitry 110 does not detect Intent when detecting Presence, the Reader Device 102 remains in standby mode.

The processing circuitry 110 may implement an intent detection algorithm. In some examples, the intent detection algorithm is implemented as a machine learning algorithm such as an ensemble decision tree, neural network, or other nonlinear multivariate method. The intent detection algorithm may be trained prior to deployment by conducting a multi-person study that enables collection of data useful to determine intent from the UWB and IMU signals. Such a study might comprise a subject population spanning a broad demographic range of people who variously seek to enter a doorway or pass by it while the sensor data is collected. In this way, sensor signals may be combined with the actual intent to build and implement an intent detection model that predicts intent with sufficient accuracy.

Building and implementing an accurate intent detection model may include inputting data to distinguish between various archetype physical access portal geometries. For example, layouts or geometries with the doorway on the side of a hallways, doors at the end of a hallway, and doors that can be approached from most directions might represent three different archetype geometries. These physical access archetype geometries may then be served by three different models or one model that uses the geometrical archetype as one of the input factors. In either approach, the installer of the system may select to which of the available model archetypes the layout of a particular installation corresponds.

In some examples, the intent detection model may be trained in situ, or partially in situ, as an alternative to a pre-trained model. For instance, the physical access system may be placed in a passive monitoring mode for some period of time following installation. The physical access system collects IMU and/or UWB signals and corresponding actions that are sufficient to build or augment an intent detection model. The building or augmentation of the intent detection model may be performed on the device, on a controller or other local system, or remotely if the physical access system is properly connected. Passive monitoring in this way could also be used for determining the geometrical archetype of the physical access portal.

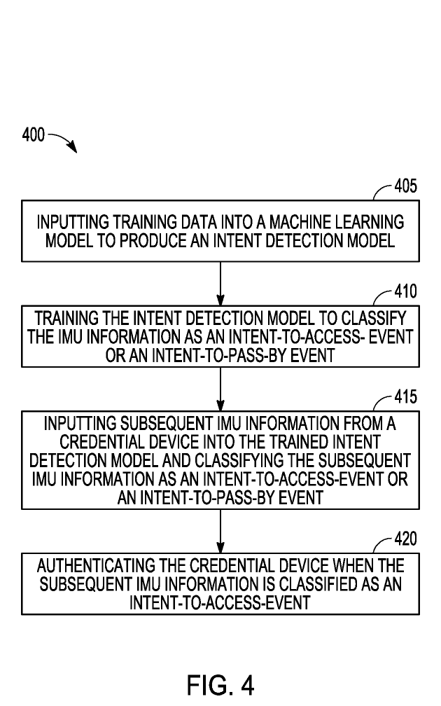

FIG. 4 is a flow diagram of an example of a method 400 of device-based detection of intent to access a physical access portal. At block 405, training data is input into a machine learning model to produce an intent detection model. The machine learning model may be an ensemble decision tree, neural network, or other nonlinear multivariate model. The training data can include layout information of a physical access portal and IMU information produced by multiple credential devices of multiple persons approaching the physical access portal. In some examples, the training data includes UWB signals produced by multiple credential devices of multiple persons approaching the physical access portal. At block 410, the intent detection model is trained to classify the IMU information and UWB signals (if available) as an intent-to-access-event or a non-access event (e.g., an intent-to-pass-by event or the user stopping to chat with a colleague or take a phone call while standing near the physical access portal) using the training data.

At block 415, subsequent IMU information from a Credential Device (e.g., Credential Device 104 in FIG. 1) is input into the trained intent detection model. The trained intent detection model may be installed or implemented in a Reader Device associated with the physical access portal (e.g., Reader Device 102 in FIG. 1) or the intent detection model may be installed on the Reader Device for the training. The trained intent detection model classifies the subsequent IMU from the Credential Device as an intent-to-access-event or an intent-to-pass-by event. In some examples, a combination of subsequent IMU information and UWB information produced by the Reader Device is input into the trained intent detection model. The trained intent detection model classifies the subsequent IMU from the credential device and the UWB information as an intent-to-access-event or an intent-to-pass-by event.

In some examples, the training data includes portal layout information, changing distance information produced by multiple reader devices, angular motion information produced by multiple credential devices, and whether the changing distance information and angular motion information corresponded to access event or a pass-by event. The trained intent detection model classifies subsequent changing distance information and angular motion information as an intent-to-access-event or an intent-to-pass-by event.

In some examples, the training data includes portal layout information, changing distance information produced by multiple reader devices, changing speed information produced by multiple credential devices, and whether the changing distance information and changing speed information corresponded to access event or a pass-by event. The trained intent detection model classifies subsequent changing distance information and changing speed information as an intent-to-access-event or an intent-to-pass-by event. In some examples, the training data includes portal layout information, changing distance information produced by multiple reader devices, acceleration information produced by multiple credential devices, and whether the changing distance information and acceleration information corresponded to access event or a pass-by event. The trained intent detection model classifies subsequent changing distance information and acceleration information as an intent-to-access-event or an intent-to-pass-by event.

At block 420, when the subsequent information (e.g., one or both of IMU information and UWB information) is classified as an intent-to-access-event, the Reader Device authenticates the credential device. The authentication is performed seamlessly without an explicit action of the user of the credential device as described previously herein regarding FIG. 2. Other information in addition to IMU and UWB information may be input to the intent detection model to detect intent. The additional information may be made available to the Reader Device by the PACS or by a different device or system.

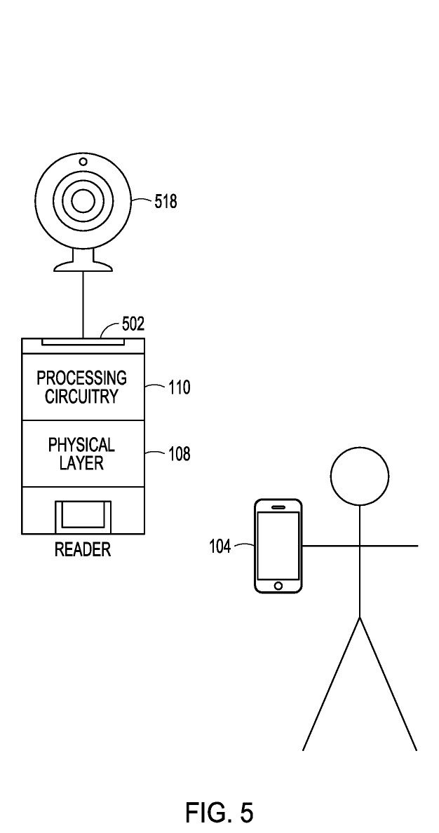

FIG. 5 is a block diagram of an example of a PACS system that includes a camera 518 to produce image or video information associated with the physical access portal. In some examples, the camera is part of a separate nearby system and the image or video information is made available for intent detection by the physical access system. The Reader Device 502 receives the image or video information from the camera 518. The Reader Device 502 determines the intent regarding whether the person intends to access the physical access portal using the video information and the IMU information. In some examples, the Reader Device 502 is UWB capable and the Reader Device 502 determines the intent regarding whether the person intends to access the physical access portal using UWB signals, IMU information, and the image or video information.

The images and video associated with the physical access portal may contain a massive amount of digital data compared to the UWB and IMU signal data volumes. In some examples, the information from images and video is preprocessed separately from the IMU and UWB information. For instance, the preprocessing of the images or video could produce skeleton images, locations of each of the salient joints on the person, or action detection (walking, turning, etc.). These preprocessed signals from the images or videos may be used as factors along with the IMU and UWB signals in determining Intent to enter the portal. For instance, the preprocessed signals from the images or videos, the IMU signals, and the UWB signals may inputs into a trained detection model implemented by the Reader Device 502.

In another approach, some or all of the intent detection is performed by the Credential Device 104 using the IMU information of the Credential Device 104. When detecting intent of the user to enter a physical access portal, the Credential Device 104 may release an Access Credential to the Reader Device 102 or send an “intent to enter” signal to the Reader Device 102 to show presence to the Reader Device 102. The Reader Device 102 may receive raw or semi-raw UWB data from the Credential Device 104 for the access, or the Reader Device 102 may receive no UWB data from the Credential Device 104.

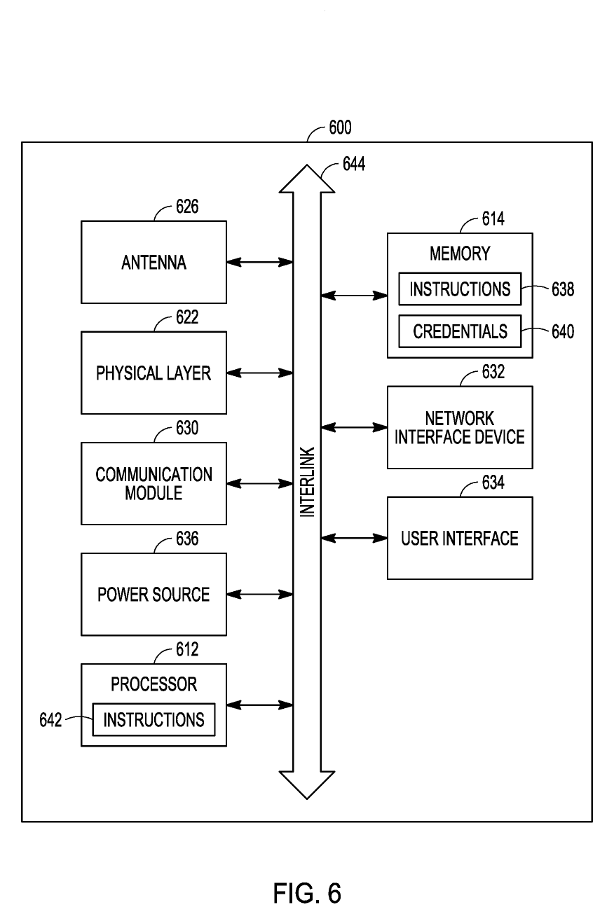

FIG. 6 is a block diagram schematic of various example components of a device 600 (e.g., a Reader Device) for supporting the device architectures described and illustrated herein. The device 600 of FIG. 6 could be, for example, a UWB capable Reader Device that authenticates credential information of authority, status, rights, and/or entitlement to privileges for the holder of a credential device. At a basic level, device 600 can include an interface (e.g., one or more antennas and Integrated Circuit (IC) chip(s)), which permits the device to exchange data with another device, such as a credential device. One example of credential device is a smartphone that has data stored thereon allowing a holder of the credential device to access a secure area or asset protected by the Reader Device.

With reference specifically to FIG. 6, additional examples of a device 600 for supporting the device architecture described and illustrated herein may generally include one or more of a memory 614, a processor 612, one or more antennas 626, a communication port or communication module 630, a network interface device 632, a user interface 634, and a power source 636 or power supply.

Memory 614 can be used in connection with the execution of application programming or instructions by processing circuitry, and for the temporary or long-term storage of program instructions 638 or instruction sets and/or authorization data, such as credential data 640, credential authorization data, or access control data or instructions, as well as any data, data structures, and/or computer-executable instructions needed or desired to support the above-described device architecture. For example, memory 614 can contain executable instructions 638 that are used by a processor 612 of the processing circuitry to run other components of device 600, to make access determinations based on credential data 640 or authorization data, and/or to perform any of the functions or operations described herein, such as the method of FIG. 2 for example. Memory 614 can comprise a computer readable medium that can be any medium that can contain, store, communicate, or transport data, program code, or instructions for use by or in connection with device 600. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Processor 612 can correspond to one or more computer processing devices or resources. For instance, processor 612 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 612 can be provided as a microprocessor, Central Processing Unit (CPU), or plurality of microprocessors or CPUs that are configured to execute instructions sets stored in an internal memory of the processor 612 and/or memory 614.

Antenna 626 can correspond to one or multiple antennas and can be configured to provide for wireless communications between device 600 and another device. Antenna(s) 626 can be coupled to one or more physical (PHY) layers 622 to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. In an example, antenna 626 may include one or more antennas coupled to one or more physical layers 622 to operate using UWB for in band activity/communication and Bluetooth (e.g., BLE) for out-of-band (OOB) activity/communication. However, any RFID or personal area network (PAN) technologies, such as the IEEE 502.15.1, near field communications (NFC), ZigBee, GSM, CDMA, Wi-Fi, etc., may alternatively or additionally be used for the OOB activity/communication described herein.

Device 600 may additionally include a communication module 630 and/or network interface device 632. Communication module 630 can be configured to communicate according to any suitable communications protocol with one or more different systems or devices either remote or local to device 600. Network interface device 632 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 632 can include an Ethernet port or other physical jack, a Wi-Fi card, a Network Interface Card (NIC), a cellular interface (e.g., antenna, filters, and associated circuitry), or the like. In some examples, network interface device 632 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 626, communication module 630, and/or network interface device 632 or subcomponents thereof, may be integrated as a single module or device, function or operate as if they were a single module or device, or may comprise of elements that are shared between them.

User interface 634 can include one or more input devices and/or display devices. Examples of suitable user input devices that can be included in user interface 634 include, without limitation, one or more buttons, a keyboard, a mouse, a touch-sensitive surface, a stylus, a camera, a microphone, etc. Examples of suitable user output devices that can be included in user interface 634 include, without limitation, one or more LEDs, an LCD panel, a display screen, a touchscreen, one or more lights, a speaker, etc. It should be appreciated that user interface 634 can also include a combined user input and user output device, such as a touch-sensitive display or the like.

Power source 636 can be any suitable internal power source, such as a battery, capacitive power source or similar type of charge-storage device, etc., and/or can include one or more power conversion circuits suitable to convert external power into suitable power (e.g., conversion of externally supplied AC power into DC power) for components of the device 600. Device 600 can also include one or more interlinks or buses 644 operable to transmit communications between the various hardware components of the device. A system bus 644 can be any of several types of commercially available bus structures or bus architectures.

### ADDITIONAL DISCLOSURE AND EXAMPLES

A first Example (Example 1) includes subject matter (such as a reader device of a physical access control system (PACS) comprising an ultra-wideband (UWB) physical layer and processing circuitry operatively coupled to the UWB physical layer. The processing circuitry is configured to detect presence of a person using a UWB signal, establish a communication channel with a credential device associated with the person, receive Inertial Measurement Unit (IMU) information from the credential device using the communication channel, determine intent regarding whether the person intends to access a physical access portal associated with the reader device using the IMU information, and initiate authentication of the credential device when the determined intent indicates the person intends to access the physical access portal.

In Example 2, the subject matter of Example 1 optionally includes processing circuitry configured to determine the intent regarding whether the person intends to access the physical access portal using the UWB signal and the IMU information.

In Example 3, the subject matter of one or both of Examples 1 and 2 optionally includes processing circuitry configured to determine change in distance of the person from the physical access portal using the UWB signal, determine angular motion of the person using the IMU information, and determine the intent regarding whether the person intends to access the physical access portal using the determined change in distance and angular motion.

In Example 4, the subject matter of one or any combination of Examples 1-3 optionally includes processing circuitry configured to determine change in distance of the person from the physical access portal using the UWB signal, determine change in speed of the person using the IMU information, and determine the intent regarding whether the person intends to access the physical access portal using the determined change in distance and change in speed.

In Example 5, the subject matter of one or any combination of Examples 1-4 optionally includes processing circuitry configured to determine distance information of the person relative to the physical access portal based on a first coordinate system using the UWB signal, receive IMU information from the credential device that is based on a different coordinate system, transform the IMU information to the first coordinate system, determine acceleration information of the person using the transformed IMU information, and determine the intent regarding whether the person intends to access the physical access portal using the determined distance information and acceleration information.

In Example 6, the subject matter of one or any combination of Examples 1-5 optionally includes processing circuitry configured to receive action information from the credential device identifying an action of the person, and determine the intent regarding whether the person intends to access the physical access portal using the action information.

In Example 7, the subject matter of one or any combination of Examples 1-6 optionally includes processing circuitry configured to receive video information associated with the physical access portal, and determine the intent regarding whether the person intends to access the physical access portal using the UWB signal, the IMU information, and the video information.

In Example 8, the subject matter of one or any combination of Examples 1-7 optionally includes processing circuitry configured to send a request to the credential device for access credential information when determining intent that the person intends to access the physical access portal, and grant access through the physical access portal according to the access credential information.

In Example 9, the subject matter of one or any combination of Examples 1-8 optionally includes executable instructions, that when performed by the processing circuitry cause the processing circuitry to perform an intent detection model to determine the intent regarding whether the person intends to access the physical access portal, and optionally includes processing circuitry configured to input the IMU information and layout information of the physical access portal into the intent detection model to produce a determination of the intent.

Example 10 includes subject matter (such as a method of operating a PACS) or can optionally be combined with one or any combination of Examples 1-9 to include such subject matter, comprising detecting, by a reader device of the PACS, presence of a person using a UWB signal, wherein the reader device is associated with a physical access portal; establishing, by the reader device, a communication channel with a credential device associated with the person; receiving IMU information from the credential device using the communication channel; receiving Inertial Measurement Unit (IMU) information from the credential device using the communication channel; and authenticating the credential device when the determined intent indicates the person intends to access the physical access portal.

In Example 11, the subject matter of Example 10 optionally includes determining the intent using the UWB signal and the IMU information.

In Example 12, the subject matter of one or both of Examples 10 and 11 optionally includes determining changing distance of the person from the physical access portal using the UWB signal, determining angular motion of the person using the IMU information, and determining, by the reader device, the intent regarding whether the person intends to access the physical access portal using the determined changing distance and angular motion.

In Example 13, the subject matter of one or any combination of Examples 10-12 optionally includes determining changing distance of the person from the physical access portal using the UWB signal; determining changing speed of the person using the IMU information; and determining, by the reader device, the intent regarding whether the person intends to access the physical access portal using the determined changing distance and changing speed.

In Example 14, the subject matter of one or any combination of Examples 10-13 optionally includes determining, by the reader device, distance information of the person relative to the physical access portal based on a first coordinate system using the UWB signal; receiving IMU information that is based on a second coordinate system; transforming, by the reader device, the IMU information to the first coordinate system; determining acceleration information of the person using the transformed IMU information; and determining, by the reader device, the intent regarding whether the person intends to access the physical access portal using the determined distance information and acceleration information.

In Example 15, the subject matter of one or any combination of Examples 10-14 optionally includes receiving action information from the credential device identifying an action of the person; and determining, by the reader device, the intent regarding whether the person intends to access the physical access portal using the action information.

In Example 16, the subject matter of one or any combination of Examples 10-15 optionally includes receiving, by the reader device, video information associated with the physical access portal; and wherein the determining the intent includes determining the intent using the UWB signal, the IMU information, and the video information.

In Example 17, the subject matter of one or any combination of Examples 10-16 optionally includes receiving, by the reader device, access credential information from the credential device when determining intent that the person intends to access the physical access portal; and granting access through the physical access portal according to the access credential information.

In Example 18, the subject matter of one or any combination of Examples 10-17 optionally includes inputting the IMU information and layout information of the physical access portal into an intent detection model of the reader device to produce a determination of the intent that the person intends to access the physical access portal.

Example 19 includes subject matter (such as a method of device-based detection of intent to access a physical access portal) or can optionally be combined with one or any combination of Examples 1-18 to include such subject matter, comprising inputting training data into a machine learning model to produce an intent detection model, wherein the training data includes layout information of a physical access portal, and IMU information produced by multiple credential devices of multiple persons approaching the physical access portal; training the intent detection model to classify the IMU information as an intent-to-access-event or an intent-to-pass-by event; inputting subsequent IMU information from a credential device into the trained intent detection model when the trained intent detection model is included in a reader device associated with the physical access portal and classifying the subsequent IMU information as an intent-to-access-event or an intent-to-pass-by event; and authenticating, by the reader device, the credential device when the subsequent IMU information is classified as an intent-to-access-event.

In Example 20, the subject matter of Example 19 optionally includes inputting UWB signal data produced by multiple reader devices into the machine learning model; training the intent detection model to classify the IMU information and the UWB signal data as the intent-to-access-event or the intent-to-pass-by event; and inputting the subsequent IMU information and subsequent UWB signal data into the trained intent detection model of the reader device and classifying the subsequent IMU information and subsequent UWB signal data as the intent-to-access-event or the intent-to-pass-by event.

In Example 21, the subject matter of Example 20 optionally includes inputting changing distance information produced by multiple reader devices and inputting angular motion information produced by multiple credential devices into the machine learning model; and training the intent detection model to classify the changing distance information and the angular motion information as the intent-to-access-event or the intent-to-pass-by event.

In Example 22, the subject matter of Example 20 optionally includes inputting changing distance information produced by multiple reader devices and inputting changing speed produced by multiple credential devices into the machine learning model; and training the intent detection model to classify the changing distance information and the changing speed information as the intent-to-access-event or the intent-to-pass-by event.

These nonlimiting Examples can be combined in any permutation or combination. The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

What is claimed is:

1. A reader device of a physical access control system (PACS), the reader device comprising:
an ultra-wideband (UWB) physical layer;
processing circuitry operatively coupled to the UWB physical layer and configured to:
detect presence of a person using a UWB signal;
establish a communication channel with a credential device associated with the person;
receive Inertial Measurement Unit (IMU) information from the credential device using the communication channel;
determine intent regarding whether the person intends to access a physical access portal associated with the reader device using the IMU information; and
initiate authentication of the credential device when the determined intent indicates the person intends to access the physical access portal.

2. The reader device of claim 1, wherein the processing circuitry is configured to:
determine the intent regarding whether the person intends to access the physical access portal using the UWB signal and the IMU information.

3. The reader device of claim 1, wherein the processing circuitry is configured to:
determine change in distance of the person from the physical access portal using the UWB signal;
determine angular motion of the person using the IMU information; and
determine the intent regarding whether the person intends to access the physical access portal using the determined change in distance and angular motion.

4. The reader device of claim 1, wherein the processing circuitry is configured to:
determine change in distance of the person from the physical access portal using the UWB signal;
determine change in speed of the person using the IMU information; and
determine the intent regarding whether the person intends to access the physical access portal using the determined change in distance and change in speed.

5. The reader device of claim 1, wherein the processing circuitry is configured to:
determine distance information of the person relative to the physical access portal based on a first coordinate system using the UWB signal;
receive IMU information from the credential device that is based on a different coordinate system;
transform the IMU information to the first coordinate system;
determine acceleration information of the person using the transformed IMU information; and
determine the intent regarding whether the person intends to access the physical access portal using the determined distance information and acceleration information.

6. The reader device of claim 1, wherein the processing circuitry is configured to:
receive action information from the credential device identifying an action of the person; and
determine the intent regarding whether the person intends to access the physical access portal using the action information.

7. The reader device of claim 1, wherein the processing circuitry is configured to:
receive video information associated with the physical access portal; and
determine the intent regarding whether the person intends to access the physical access portal using the UWB signal, the IMU information, and the video information.

8. The reader device of claim 1, wherein the processing circuitry is configured to:
send a request to the credential device for access credential information when determining intent that the person intends to access the physical access portal; and
grant access through the physical access portal according to the access credential information.

9. The reader device of claim 1, including:
executable instructions, that when performed by the processing circuitry cause the processing circuitry to perform an intent detection model to determine the intent regarding whether the person intends to access the physical access portal; and
wherein the processing circuitry is configured to input the IMU information and layout information of the physical access portal into the intent detection model to produce a determination of the intent.

10. A method of operating a physical access control system (PACS), the method comprising:
detecting, by a reader device of the PACS, presence of a person using an ultra-wideband (UWB) signal, wherein the reader device is associated with a physical access portal;
establishing, by the reader device, a communication channel with a credential device associated with the person;
receiving Inertial Measurement Unit (IMU) information from the credential device using the communication channel;
determining intent using the IMU information regarding whether the person intends to access the physical access portal; and
authenticating the credential device when the determined intent indicates the person intends to access the physical access portal.

11. The method of claim 10, wherein the determining the intent includes determining the intent using the UWB signal and the IMU information.

12. The method of claim 10, wherein the determining the intent includes:
determining changing distance of the person from the physical access portal using the UWB signal;
determining angular motion of the person using the IMU information; and
determining, by the reader device, the intent regarding whether the person intends to access the physical access portal using the determined changing distance and angular motion.

13. The method of claim 10, wherein the determining the intent includes:
determining changing distance of the person from the physical access portal using the UWB signal;
determining changing speed of the person using the IMU information; and
determining, by the reader device, the intent regarding whether the person intends to access the physical access portal using the determined changing distance and changing speed.

14. The method of claim 10, wherein the determining the intent includes:
determining, by the reader device, distance information of the person relative to the physical access portal based on a first coordinate system using the UWB signal;
receiving IMU information that is based on a second coordinate system;
transforming, by the reader device, the IMU information to the first coordinate system;
determining acceleration information of the person using the transformed IMU information; and
determining, by the reader device, the intent regarding whether the person intends to access the physical access portal using the determined distance information and acceleration information.

15. The method of claim 10, including:
receiving action information from the credential device identifying an action of the person; and
determining, by the reader device, the intent regarding whether the person intends to access the physical access portal using the action information.

16. The method of claim 10, including:
receiving, by the reader device, video information associated with the physical access portal; and
wherein the determining the intent includes determining the intent using the UWB signal, the IMU information, and the video information.

17. The method of claim 10, including:
receiving, by the reader device, access credential information from the credential device when determining intent that the person intends to access the physical access portal; and
granting access through the physical access portal according to the access credential information.

18. The method of claim 10, including inputting the IMU information and layout information of the physical access portal into an intent detection model of the reader device to produce a determination of the intent that the person intends to access the physical access portal.

19. A method of device-based detection of intent to access a physical access portal, the method comprising:
inputting training data into a machine learning model to produce an intent detection model, wherein the training data includes:
layout information of a physical access portal; and
Inertial Measurement Unit (IMU) information produced by multiple credential devices of multiple persons approaching the physical access portal;
training the intent detection model to classify the IMU information as an intent-to-access-event or an intent-to-pass-by event;
inputting subsequent IMU information from a credential device into the trained intent detection model when the trained intent detection model is included in a reader device associated with the physical access portal and classifying the subsequent IMU information as an intent-to-access-event or an intent-to-pass-by event; and
authenticating, by the reader device, the credential device when the subsequent IMU information is classified as an intent-to-access-event.

20. The method of claim 19,
wherein the inputting the training data includes inputting UWB signal data produced by multiple reader devices into the machine learning model;
wherein the training the intent detection model includes training the intent detection model to classify the IMU information and the UWB signal data as the intent-to-access-event or the intent-to-pass-by event; and
wherein the inputting the subsequent IMU information includes inputting the subsequent IMU information and subsequent UWB signal data into the trained intent detection model of the reader device and classifying the subsequent IMU information and subsequent UWB signal data as the intent-to-access-event or the intent-to-pass-by event.

21. The method of claim 20,
wherein the inputting the training data includes inputting changing distance information produced by multiple reader devices and inputting angular motion information produced by multiple credential devices into the machine learning model; and
wherein the training the intent detection model includes training the intent detection model to classify the changing distance information and the angular motion information as the intent-to-access-event or the intent-to-pass-by event.

22. The method of claim 20,
wherein the inputting the training data includes inputting changing distance information produced by multiple reader devices and inputting changing speed produced by multiple credential devices into the machine learning model; and
wherein the training the intent detection model includes training the intent detection model to classify the changing distance information and the changing speed information as the intent-to-access-event or the intent-to-pass-by event.
